(19) United States
(12) Patent Application Publication
(10) Pub. No.: US 2026/0238959 A1
(43) Pub. Date: Aug. 13, 2026

(54) DISCOVERY AND SELECTION OF LOCATED WTRU PER TARGET WTRU'S STATUS

(71) Applicant: InterDigital Patent Holdings, Inc., Wilmington, DE (US)

(72) Inventors: Jung Je Son, Warrington, PA (US); Anuj Sethi, Ottawa (CA); Taimoor Abbas, Sainte-Julie (CA); Alec Brusilovsky, Downingtown, PA (US); Fumihiro Hasegawa, Westmount (CA); Tao Deng, New York, NY (US); Tuong Hoang, Montreal (CA)

(73) Assignee: InterDigital Patent Holdings, Inc., Wilmington, DE (US)

(21) Appl. No.: 19/472,972

(22) PCT Filed: Apr. 5, 2024
(86) PCT No.: PCT/US2024/023440

§ 371 Date: Oct. 6, 2025

Related U.S. Application Data
(60) Provisional application No. 63/457,565, filed on Apr. 6, 2023.

(51) Int. Cl. H04W 4/02; G01S 13/76; H04W 76/14

(52) U.S. Cl. CPC H04W 4/023; G01S 13/765; H04W 76/14

(57) ABSTRACT

A first wireless transmit/receive unit (WTRU) may be used to provide an SL. positioning service. The first WTRU may comprise a processor. A solicitation message may be received from a second WTRU. The solicitation message may indicate a status of a second WTRU and may indicate service information associated with an SL positioning service, It may be determined that the first WTRU is capable of providing the SL positioning service based on the status of the second WTRU and the service information. A response message may be sent to the second WTRU when the first WTRU is capable of providing the SL positioning service.

### CROSS REFERENCE TO RELATED APPLICATIONS

This application claims the benefit of Provisional Patent Application No. 63/457,565, filled Apr. 6, 2023, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and apparatus are disclosed herein for providing methods of discovery and/or selection of located wireless transmit/receiver unit (WTRU) per a target WTRU's status. A target WTRU may send a solicitation message for model B discovery to discover a located WTRU for SL positioning service. The solicitation message may include the target WTRU's status and/or requested capabilities of the located WTRU so that the target WTRU may discover and select an appropriate WTRU to perform SL positioning.

A first wireless transmit/receive unit (WTRU) may perform (e.g., be configured to perform) one or more of the following. The first WTRU may receive a solicitation message from a second WTRU. The solicitation message may indicate a status of the second WTRU and/or service information associated with a sidelink (SL) positioning service. The first WTRU may determine that the first WTRU is capable of providing the SL positioning service based on the status of the second WTRU and the service information. The first WTRU may send a response message to the second WTRU based on the determination that the first WTRU is capable of providing the SL positioning service. The response message may indicate the first WTRU is capable of providing the SL positioning service.

The first WTRU may receive a connection request message from the second WTRU to establish a connection and establish a connection to the second WTRU. The first WTRU may perform an SL positioning operation using the connection to the second WTRU. The SL positioning operation may be based on the status of the second WTRU. The status of the second WTRU may indicate whether or not the second WTRU has a non-access stratum (NAS) connection available. The SL positioning operation may be a synchronization method.

The solicitation message may indicate a connection status associated with the second WTRU, a positioning method, and/or a location associated with the second WTRU. The response message may indicate a capability of the first WTRU to perform an SL positioning operation associated with the status of the second WTRU. In examples, the response message may not be integrity protected (e.g., so the response message may be sent via the connection). In examples, the response message is integrity protected and confidentiality protected.

A first wireless transmit/receive unit (WTRU) may perform (e.g., be configured to perform) one or more of the following. The first WTRU may receive an announcement message from a second WTRU. The announcement message may indicate service information associated with a sidelink (SL) positioning service, an identity of the second WTRU, and/or a capability of the second WTRU to support the SL positioning service. The first WTRU may determine that the second WTRU is configured to provide the SL positioning service to the first WTRU based on a status of the first WTRU and the capability of the second WTRU. The first WTRU may establish a connection to the second WTRU based on the determination that the second WTRU is configured to provide the SL positioning service.

In examples, the first WTRU may receive a service message from the second WTRU using the connection. The service message may be associated with the SL positioning service. The SL positioning service may be a round-trip time (RTT) positioning method or a time difference of arrival (TDOA) positioning method.

The status of the first WTRU may indicate whether or not the first WTRU has a non-access stratum (NAS) connection available.

In examples, the first WTRU may receive a second announcement message from a third WTRU. The determination that the second WTRU is to provide the SL positioning service may be based on the second announcement message. The determination that the second WTRU is to provide the SL positioning service may be based on a link quality associated with the first WTRU.

The first WTRU may receive a candidate list indicating the capability of the second WTRU to support the SL positioning service. The candidate list may include a first set of WTRUs associated with a first SL positioning service and a second set of WTRUs associated with a second SL positioning service. For example, the first set of WTRUs may include the second WTRU, and the first SL positioning service may be the SL positioning service.

A first wireless transmit/receive unit (WTRU) may be used to provide an SL positioning service. The first WTRU may comprise a processor. A solicitation message may be received from a second WTRU. The solicitation message may indicate a status of a second WTRU and may indicate service information associated with an SL positioning service. It may be determined that the first WTRU is capable of providing the SL positioning service based on the status of the second WTRU and the service information. A response message may be sent to the second WTRU when the first WTRU is capable of providing the SL positioning service.

A first wireless transmit/receive unit (WTRU) may be used to receive a service message associated with an SL positioning service. An announcement message may be received from a second WTRU, indicating service information associated with the SL positioning service, the identity of the second WTRU, and a capability of the second WTRU to support the SL positioning service. It may be determined that the second WTRU is to provide the SL positioning service based on a status of the first WTRU and the capability of the second WTRU. A connection may be established to the second WTRU based on the determination that the second WTRU is to provide the SL positioning service. The service message may be received from the second WTRU using the connection.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example architecture of a network.

FIG. 3 is a system diagram illustrating an example architecture of a network that may be used for or to provide location service.

FIG. 4 is a system diagram illustrating an example positioning control plane (CP)/user plane (UP) architecture.

FIG. 5 is a flow diagram illustrating an example method of discovery and selection of a located WTRU with discovery.

FIG. 6 is a flow diagram illustrating an example method of discovery and selection of a located WTRU with discovery.

FIG. 7 is a flow diagram illustrating an example method of a SL positioning protocol between a target WTRU and a located WTRU.

### DETAILED DESCRIPTION

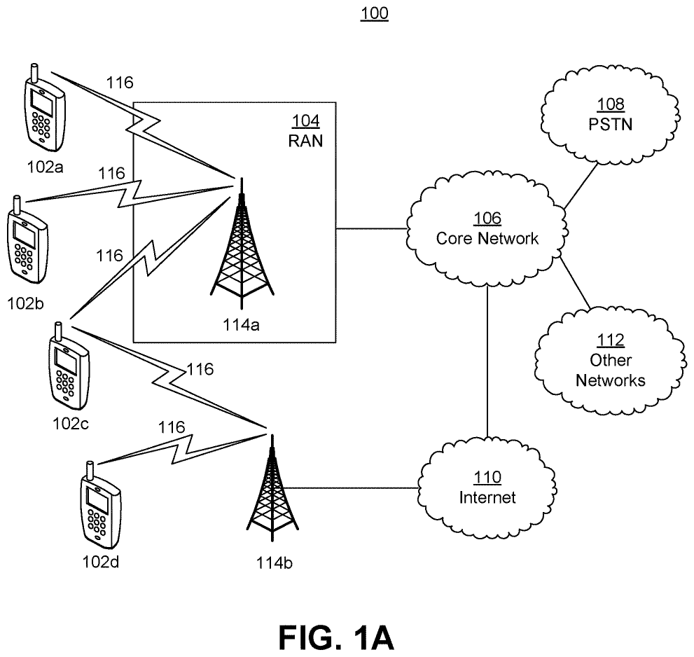

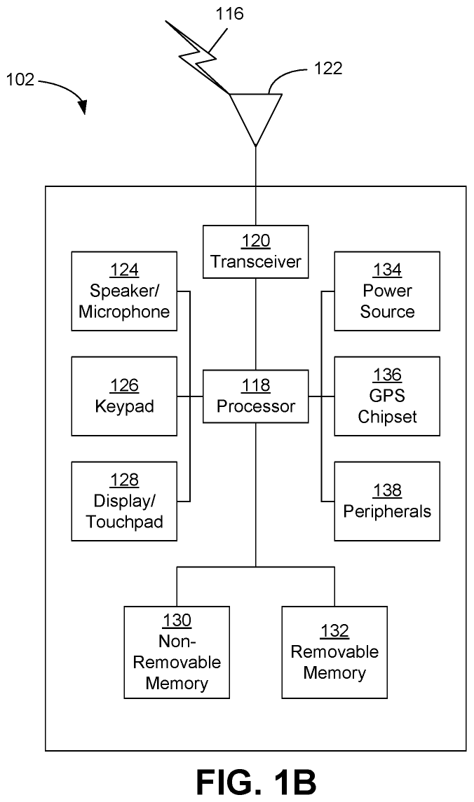

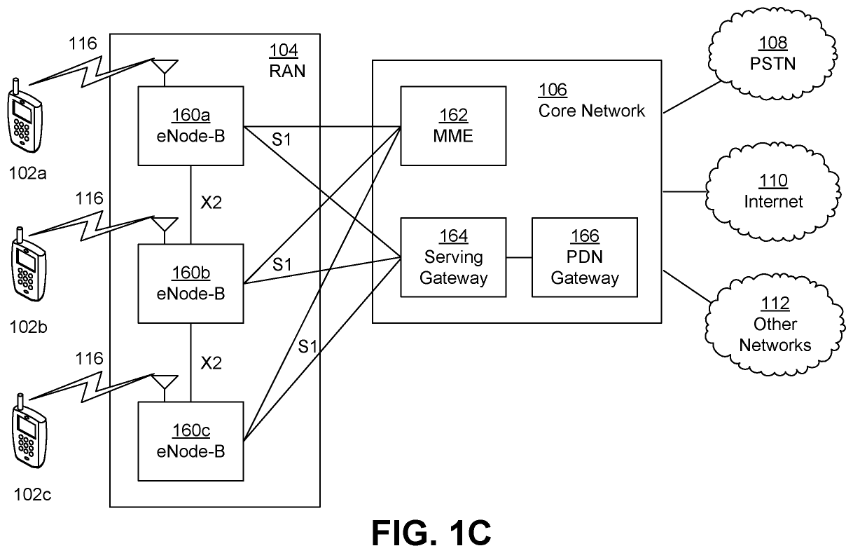

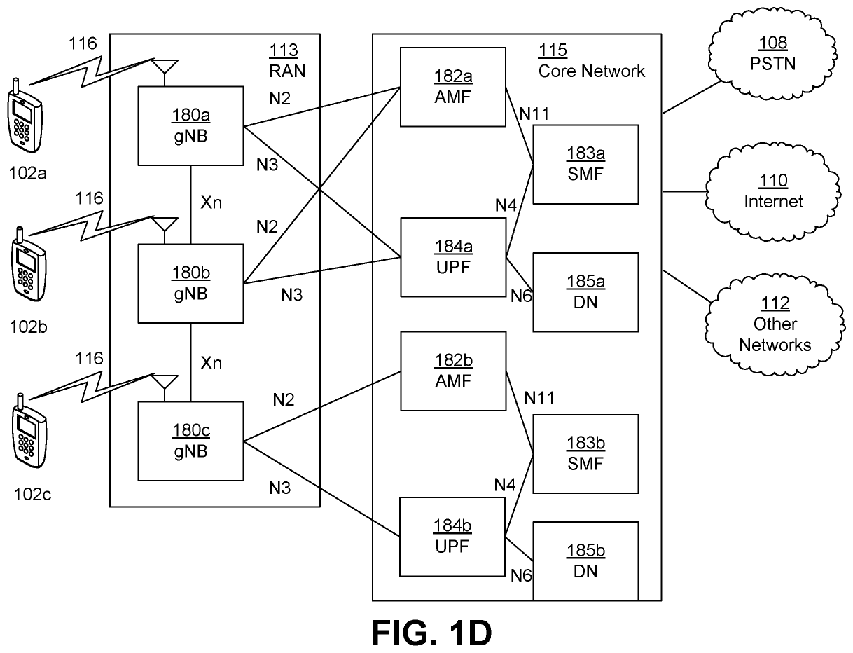

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 1020 and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 1020, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 1020, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+), HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN), In an embodiment, the base station 114b and the WTRUs 1020, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 1020, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WIFI radio technology.

The CN 106/115 may also serve as a gateway for the WTRUs 102a, 102b, 1020, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102, As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 1600 may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 1600 in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 1020, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes, Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code,

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 1800, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 1800 may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 1800 as a mobility anchor point. In the standalone configuration, WTRUs 102a, 102b, 102c may communicate with gNBs 180a, 180b, 1800 using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 1020 based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-horned PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

The following abbreviations may be used herein: non-access stratum (NAS), sidelink (SL)-based positioning (SL positioning), radio access technology (RAT), radio access network (RAN), or proximity-based service (ProSe).

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and apparatus are disclosed herein for providing methods of discovery and/or selection of a located WTRU, for example, based on a target WTRU's status. For example, discovery and/or selection over PC5 based on 5G ProSe may be provided. Ranging and SL positioning protocol (RSPP) may be provided for SL positioning operation over a PC5 connection.

Discovery may generally refer to the process by which devices find and connect to other devices and/or available network resources. Discovery may involve procedures, such as scanning for available networks, identifying suitable access points, and establishing initial communication with the network. In examples, two approaches of discovery may be defined. A first discovery approach may be referred to as model A discovery and may generally incorporate proactive reporting (e.g., by a device). A second discovery approach may be referred to as model B discovery and may generally incorporate proactive polling/requesting (e.g., by a device). In examples, a device may be configured to employ multiple discovery approaches (e.g., in difference scenarios).

Model A discovery (e.g., which may be referred to as “I am here” discovery) may be a method used by a monitoring WTRU (e.g., a target WTRU) to discover an announcing WTRU (e.g., a located WTRU), for example, by receiving/monitoring an announcement message of the announcing WTRU. An announcing WTRU may be the WTRU that announces information (e.g., without receiving an explicit request from a monitoring WTRU). The announced information may be used by WTRUs in proximity to the announcing WTRU that have permission to discover (e.g., monitoring WTRUs). A monitoring WTRU may be a WTRU that monitors information of interest in the proximity of announcing WTRUs. In model A, the announcing WTRU may broadcast discovery messages at pre-defined discovery intervals, and the monitoring WTRUs interested in these messages may receive and process them. Announced information may include, for example, one or more of SL positioning capabilities (e.g., of the announcing WTRU), a location associated with the announcing WTRU, or an indication of the announcing WTRU's capability to support a monitoring WTRU (e.g., depending on a status of the monitoring WTRU).

For model A discovery, a located WTRU may send an announcement message. The announcement message may include the located WTRU's supported capabilities (e.g., such that it may perform required procedures for SL positioning with a target WTRU that has no NAS connection). Based on the announced supported capabilities, the target WTRU may discover and select the located WTRU, for example, to perform SL positioning. In examples, the target WTRU may wait for a period of time (e.g., for a timer expiration) so that the target WTRU may receive announcement information from multiple located WTRUS.

The target WTRU may select the located WTRU further based on a status of the target WTRU. In examples, a status of a target WTRU may indicate the target WTRU's NAS connectivity (e.g., whether the target WTRU has a NAS connection or not). A located WTRU may provide the requested capability (e.g., for SL positioning) per the target WTRU's status. The target WTRU and the selected located WTRU may setup a PC5 connection and/or perform an SL positioning operation (e.g., based on the target WTRU's status).

Model B discovery (which may be referred to as “who is there” or “are you there” discover) may be a method used by a discoverer WTRU (e.g., a target WTRU) to discover a discoveree WTRU (e.g., a located WTRU) by sending a solicitation request message and receiving a response message (e.g., from the discoveree WTRU). The discoverer WTRU may be the WTRU that transmits a request for information (e.g., an indication of whether the discoveree WTRU is capable of providing a service to the discoverer WTRU). The discoveree WTRU may be the WTRU that receives the request message and may respond with some information related to the discoverer's request.

For model B discovery, the target WTRU may send a solicitation message to discover a located WTRU, for example, for the located WTRU to provide an SL positioning service. The solicitation message may include the target WTRU's status (e.g., whether the target WTRU has a NAS connection or not) and/or requested capabilities of a located WTRU. The solicitation message may be configured so that the target WTRU may discover and select a located WTRU which is configured to provide a service (e.g., a SL positioning procedure) based on the target WTRU's status. In examples, the target WTRU may wait for a period of time (e.g., for a timer expiration) so that the target WTRU may receive responses from multiple located WTRUs before selecting a located WTRU. In examples, the target WTRU may wait to select a located WTRU until it has received responses from multiple located WTRUs (e.g., a number of located WTRUs or al located WTRU's to which solicitation messages were sent).

The target WTRU may select a located WTRU, for example, based on the located WTRU's capability to provide the target WTRU with a service per the target WTRU's status. The target WTRU and a selected located WTRU may establish (e.g., setup) a PC5 connection. The target WTRU and the selected located WTRU may perform SL positioning operation (e.g., via the PC5 connection) per the target WTRU's status.

In an example, for the SL positioning operation, a target WTRU and a located WTRU may negotiate the target WTRU's status. The target WTRU's status may indicate whether the target WTRU may or may not have a NAS connection. A requested located WTRU's capability may be provided per a target WTRU's status so that an SL positioning method (e.g., synchronization method, measuring mechanism, etc.) and/or a role of one or more WTRUs, such as which entity may make location report, may be determined (e.g., based on the target WTRU's status and a located WTRU's capability). For example, the target WTRU may determine the located WTRU's capability is associated with a particular SL positioning method.

A located wireless transmit/receive unit (WTRU) (e.g., a first WTRU) may comprise a processor and may (e.g., be configured to) perform one or more of the following (e.g., for model B discovery). The located WTRU may be configured to provide an SL positioning service. The located WTRU may receive a solicitation message from a target WTRU (e.g., a second WTRU). The solicitation message may indicate a status of the target WTRU and/or service information associated with an SL positioning service. The located WTRU may determine that the located WTRU is capable of providing the SL positioning service to the target WTRU, for example, based on the solicitation message. The located WTRU may send a response message to the target WTRU, Including an indication that the located WTRU is capable of providing the SL positioning service.

In examples, the solicitation message may indicate one or more of: a requested capability, a connection status associated with the target WTRU, a positioning method, or a location (e.g., associated with the target WTRU). In examples, the response message may include information about one or more of a requested capability or a capability associated with the status of the target WTRU.

In examples, the located WTRU may receive a connection request message from the target WTRU. The connection request message may indicate a request to establish a connection (e.g., a PC5 connection) with the located WTRU. A connection may be established between the located WTRU and the target WTRU, for example, based on the received connection request message. An SL positioning operation may be performed, for example, using the connection between the located WTRU and the target WTRU. The performed SL positioning operation may be based on the status of the target WTRU (e.g., whether the target WTRU has a NAS connection).

A target wireless transmit/receive unit (WTRU) (e.g., a first WTRU) may comprise a processor and may (e.g., be configured to) perform one or more of the following (e.g., for model A discovery). The target WTRU may receive a service message associated with an SL positioning service. The target WTRU may receive an announcement message from a located WTRU (e.g., a second WTRU). The announcement message may indicate service information associated with the SL positioning service, the identity of the located WTRU, and/or a capability of the located WTRU to support the SL positioning service. The target WTRU may determine that the located WTRU is capable of providing (e.g., configured to provide) the SL positioning service. The determination that the located WTRU is capable of providing the SL positioning service may be based on a status of the target WTRU and/or the capability of the located WTRU. The target WTRU may select the located WTRU based on the determination. A connection may be established to the selected located WTRU, for example, based on the determination that the located WTRU is to provide the SL positioning service. The target WTRU and the selected located WTRU may perform the SL positioning service, for example, over the connection. The performed SL positioning service may be based on the status of the target WTRU.

In examples, the determination that the located WTRU is to provide the SL positioning service (e.g., the selection of the located WTRU) may be further based on a NAS connection status associated with the target WTRU.

In examples, the announcement message may be a first announcement message, and a second announcement message may be received from a third WTRU. The determination that the located WTRU may provide the SL positioning service (e.g., the selection of the located WTRU) may be further based on the second announcement message.

A located wireless transmit/receive unit (WTRU) (e.g., a first WTRU) may comprise a processor and may (e.g., be configured to) perform one or more of the following (e.g., for SL positioning protocol). The located WTRU may be used to perform a positioning-based operation. The located WTRU may receive a first message from a target WTRU (e.g., a second WTRU) that indicates a connection status associated with the target WTRU. A negotiated capability may be determined based on the connection status, a capability of the located WTRU, and a capability of a third WTRU (e.g., a SL positioning server, a SL reference WTRU). The located WTRU may determine and/or receive a SL positioning operation. The located WTRU may perform the SL positioning operation using the negotiated capability. The SL positioning operation may be, for example, a synchronization method or a measuring mechanism.

In examples, the located WTRU may receive a service message, for example, from the target WTRU and/or the third WTRU, that indicates a result of the SL positioning operation.

In examples, an assistance message may be received from the third WTRU that includes assistance data associated with the SL positioning method. For example, the assistance data may be a characteristic and format of a transmitted signal and/or a time slot.

In examples, the located WTRU may send a report message associated with the performed SL positioning operation. The report message may be sent, for example, to the target WTRU and/or the third WTRU. The report message may include data associated with a result of the SL operation. For example, the result of the SL positioning operation may have been received by the located WTRU. For example, the result of the SL positioning operation may have been determined by the located WTRU (e.g., using collected data from the performance of the SL positioning operation).

Discovery and/or selection of a located WTRU per a target WTRU's status (e.g., connection status) may be provided.

Discovery and/or selection of a located WTRU through model B discovery may be performed. For model B discovery, a target WTRU may send a solicitation message to discover a located WTRU, for example, which may provide an SL positioning service. The target WTRU may include the target WTRU's status and/or requested capabilities of located WTRU in the solicitation message (e.g., such that target WTRU may discover and select the located WTRU to perform SL positioning according to the target WTRU's status). A target WTRU and a selected located WTRU may set up a PC5 connection and perform an SL positioning operation based on the target WTRU's status.

Discovery and/or selection of a located WTRU through model A discovery may be provided. For model A discovery, a located WTRU may send an announcement message. The announcement message may indicate the supported capabilities of the located WTRU to perform procedures for SL positioning with a target WTRU that may not have a NAS connection. Based on announced capabilities, the target WTRU may discover the located WTRU and/or select the located WTRU to perform an SL positioning operation according to the target WTRU's status (e.g., whether the target WTRU may or may not have a NAS connection). A target WTRU and a selected located WTRU may set up a PC5 connection and may perform the SL positioning operation, for example, according to the target WTRU status.

The target WTRU may share its status as to whether it has a NAS connection available or not. The target may share its status to select the proper SL positioning method and/or to decide a (e.g., each) WTRU's role in the SL positioning operation. For example, the target WTRU may share its status while the target WTRU and located WTRU perform the SL positioning operation. Based on the target WTRU's status and the determined SL positioning method, it may be determined (e.g., by the target WTRU, the selected located WTRU, or a different WTRU) if the selected located WTRU or the target WTRU may collect the result of SL positioning and report the result to the network.

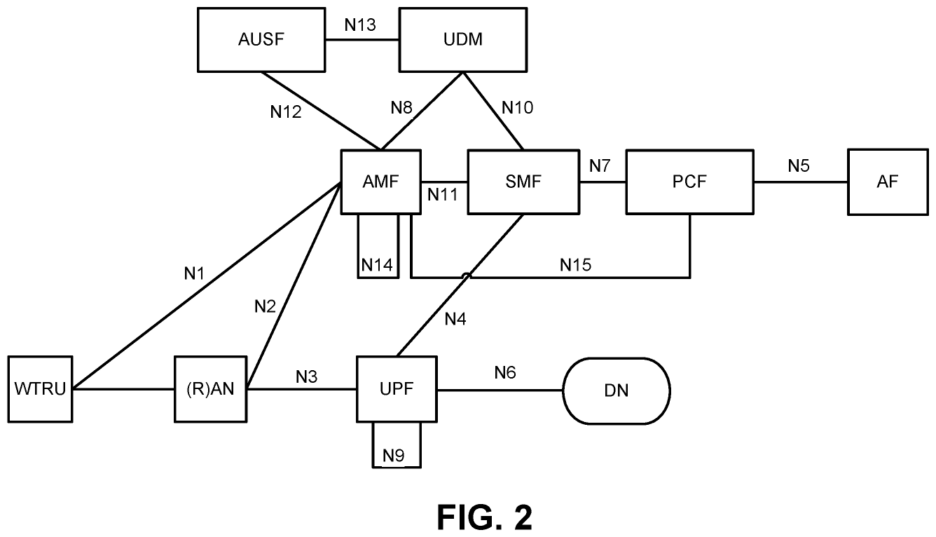

FIG. 2 is a system diagram illustrating an example architecture of a 5G or a NextGen network.

As described herein, a RAN may refer to a radio access network based on the 5G RAT or Evolved E-UTRA that connects to the NextGen core network.

An access control and mobility management function (AMF) may include functionality such as registration management, connection management, reachability management, mobility management, etc.

A session management function (SMF) may include functionality such as session management (e.g., including session establishment, modification, and/or release); WTRU IP address allocation; selection and control of UP function; etc.

A user plane function (UPF) may include functionality such as packet routing and forwarding; packet inspection; traffic usage reporting; and other functionalities.

Location service (LCS), such as a 5G location service may be provided. A location service (e.g., 5G location service) may provide the functionality to provide the positioning information of a WTRU.

The positioning of a WTRU may be supported by a RAT position method, which may rely on measurements. For example, RAT measurements (e.g., 3GPP RAT measurements) obtained by a target WTRU and/or on measurement obtained by an access network of RAT signals (e.g., 3GPP RAT signals) transmitted by a target WTRU. Positioning of a WTRU may be supported by RAT independent position methods, which may rely on non-RAT measurements obtained by a WTRU and/or on other information.

Location information for one or more target WTRUs may be requested by and reported to an LCS, a client, and/or an application function (AF) within or external to an operating network (e.g., a 3GPP operator network), or a control plane network function (NF) within a system (e.g., a 3GPP system).

For location requests from an LCS client or an AF, it may be requested that privacy verification of the target WTRU be enabled to check whether it may be allowed to acquire the WTRU location information.

Several different types of location requests may be supported.

A mobile terminated location request (MT-LR) request may be supported. An LCS client or AF may send an MT-LR to the network (e.g., 5G Network) for the location of a target WTRU.

A mobile originated location request (MO-LR) may be supported. When a MO-LR occurs, the WTRU may send a request to the network (e.g., 5G Network) for location related information for the WTRU.

An immediate location request may be supported. With an immediate location request, an LCS client, or AF may send or instigate a location request for a target WTRU(s) and may receive a response containing location information for the target WTRU(s) within a short time period. It may be used for an MT-LR or MO-LR.

A deferred location request may be supported. With a deferred location request, an LCS client or AF may send a location request to the network (e.g., 5G network) for a target WTRU(s) and may expect to receive a response when an indicated event may occur for the possible target WTRU at some future time. It may be used for an MT-LR.

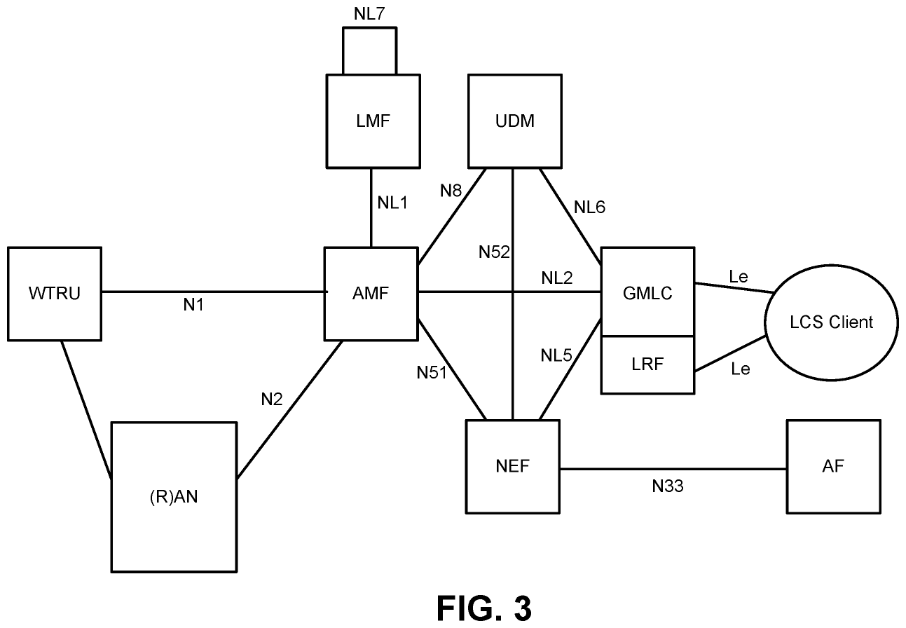

FIG. 3 is a system diagram illustrating an example architecture of a 5G or a NextGen network that may be used for or to provide location service. As shown in FIG. 3, (R)AN may represent an NG-RAN, a trusted non-3GPP access, or an untrusted non-3GPP access. The access network may be involved in handling various positioning procedures, including positioning of a target WTRU, provision of location-related information that may not be associated with a particular target WTRU, and transfer of positioning messages between an AMF or LMF and a target WTRU.

AFs and NFs may access LCS services from a GMLC in the same 3GPP operator network.

LCS clients may access LCS services from a GMLC, and external AF may access LCS services from a NEF.

The gateway mobile location center (GMLC) may handle the requests from external LCS clients, AF, via NEF if the AF may be external AF, and forward the location request to the proper NF.

A location retrieval function (LRF) may be responsible for retrieving or validating location information. LRF may be collocated with a GMLC (gateway mobile location center), or LRF may be located separately.

A location management function (LMF) may manage the overall coordination and scheduling of resources requested (e.g., required) for the location of a WTRU that may be registered with or accessing a core network (e.g., 5GCN). It may calculate or verify location-related information and achieve accuracy.

Positioning protocols and signals, such as NR positioning protocols and signals, may be provided. Positioning protocols and RAN-based positioning signals may be used to enable emergency and location-based services.

Positional protocols, such as NR positioning protocols, may be supported by the Control Plane (CP) positioning architecture over the Uu interface (NG-RAN node to WTRU). Position architecture, such as the NR positioning architecture, may be supported by a Secure User Plane Location (SUPL) server, which may be referred to as a SUPL Location platform (SLP) or location server, which may leverage any Internet Protocol bearer. Interworking for CP and UP positioning solutions may be provided, where SUPL may be used as a tunnel for CP positioning protocols (e.g., LPP).

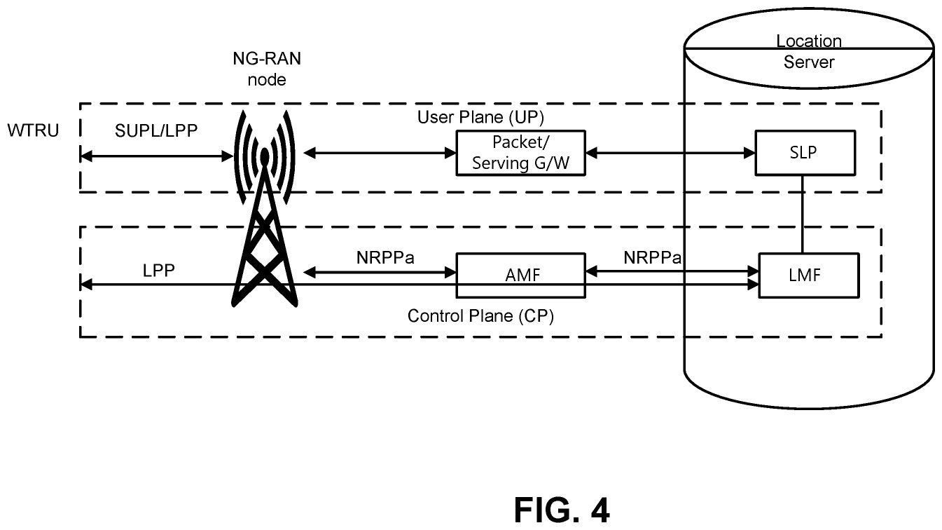

FIG. 4 is a system diagram illustrating an example positioning control plane (CP)/user plane (UP) architecture, such as a new radio (NR) positioning CP/UP architecture.

Various protocols may be used to enable several positioning technologies and methods (GNSS, sensors, positioning signals, etc.). For example, LPP (LTE Positioning protocol), may be terminated between the WTRU and LMF (Location Management Function). LPP may be a Point-to-Point LCS (location services) and non-access stratum (NAS) messaging protocol.

Radio resource control (RRC) may be a protocol used to provide transport for LPP messages and other positioning procedures over the NR-Uu interface, which may be terminated between the gNB and the WTRU.

On the network side, the NG application protocol (NGAP) may be terminated between the AMF and the NG-RAN node(s) (e.g., gNB/TRP). It may be used as a transport for LPP and NR positioning protocol A (NRPPa) messages over the NG-C interface. NRPPa may carry information between the NG-RAN Node(s) and the LMF.

NR Positioning modes may be provided. Positioning may be done in standalone, WTRU-based, or WTRU-assisted modes.

In standalone positioning, the WTRU may handle one or more (e.g., all) aspects of the positioning, may scan for accessible sources of positioning and measurement, and/or may process positioning signals/sources. The WTRU may compute its own position in two or more dimensions, such as two or three dimensions. In standalone positioning, the Uu interface may impact the WTRU capability exchange and/or reporting of the WTRU position.

In WTRU-based positioning, which may be referred to as WTRU-based positioning (WTRU-B), the network may provide acquisition assistance data, and the WTRU may scan for accessible sources of positioning and measurement and may process positioning signals/sources (e.g., based on assistance information from the network). The WTRU may compute its position using two or more dimensions (e.g., in two or three dimensions) and report its position to the network.

In WTRU-assisted positioning, which may be referred to as WTRU-assisted positioning (WTRU-A), the network may provide acquisition assistance, and the WTRU may scan for accessible sources of positioning and measure positioning signals/sources (e.g., based on assistance information from NW). The WTRU may return measurements to the network, and the network may compute the device position (e.g., at the location server/LMF).

Table 1 shows techniques of WTRU positioning methods that may be supported.

TABLE 1
Techniques of WTRU Positioning Methods

| | | WTRU-assisted, |
|---|---|---|
| Method | WTRU-based | LMF-based |
| DL-TDOA | Yes | Yes |
| DL-AoD | Yes | Yes |
| Multi-RTT | No | Yes |
| NR E-CID | No | Yes |
| UL-TDOA | No | No |
| UL-AoA | No | No |

A timing/angle positioning method may refer to a (e.g., any positioning method) that may use reference signals such as SL-PRS. The WTRU may receive multiple reference signals from WTRU(s) and measure RSTD, RSRP, and/or AoA. Examples of angle/timing positioning methods are SL-AoD or SL-TDOA positioning. Another example may be the WTRU transmitting SL-PRS to WTRU(s) and the receiver performing measurements (e.g., RSTD, AoA, RSRP) for determination of the locations of the WTRU which transmitted the SL-PRS.

An “RTT positioning method” may refer to any positioning method where two WTRUs may transmit SL-PRS to each other. In an example, an anchor WTRU may transmit SL-PRS to the target WTRU. The target WTRU may receive SL-PRS from the anchor WTRU, and the target WTRU may transmit SL-PRS to the anchor WTRU. The target WTRU may measure the WTRU Tx-Rx time difference (e.g., which may be the difference between the transmission time of SL PRS from the target WTRU and the reception time of SL-PRS transmitted from the anchor WTRU). The target WTRU may report the WTRU Tx-Rx time difference to the anchor WTRU, server WTRU, and/or network (e.g., gNB, LMF).

LTE positioning protocol (LPP) may be performed. The LPP messages related to WTRU-assisted location requests may include a number of procedures. Capabilities may be requested, for example, in an LMF request to a WTRU. Capabilities may be provided, for example, in a WTRU response to the LMF. Assistance data may be requested, for example, in a WTRU request to the LMF for positioning assistance data/information.

Assistance data may be provided (e.g., to a WTRU). For example, an LMF may send a WTRU positioning assistance data information/configuration. Positioning assistance data (AD) may be broadcast via positioning system information blocks (posSIBs) and/or carried in SI messages.

Location information may be requested and provided. For example, an LMF may send a request to a WTRU for position/measurements. The WTRU may send a response to the LMF with its position and/or measurements.

A device may be able to abort an LPP session. Errors associated with positioning procedure(s) may be identified and/or handled.

An SL positioning service may be provided. SL positioning may be used, for example, by a positioning WTRU to obtain the absolute position, relative position, or ranging information (e.g., via PC5).

Ranging may refer to a determination of the distance between two or more WTRUs and/or the direction of one WTRU (e.g., a target WTRU) from another WTRU (e.g., a reference WTRU) via an interface, such as the PC5 interface.

A target WTRU, an SL reference WTRU, an SL positioning client WTRU, and a located WTRU may be provided for SL positioning.

A target WTRU may be provided. A target WTRU may be a WTRU whose distance, direction and/or position may be measured with the support from one or more SL reference WTRUs, for example, using SL in the ranging based service and SL positioning.

A located WTRU may be provided. A located WTRU may be an SL reference WTRU of which the location is known or is able to be known, for example, using Uu based positioning. A located WTRU may be used to determine the location of a target WTRU using SL positioning.

A SL reference WTRU may be provided. An SL Reference WTRU may support the positioning of a target WTRU, for example, by transmitting and/or receiving reference signals for positioning, providing positioning-related information, etc., using SL.

A SL positioning client WTRU may be provided. A SL positioning client WTRU may be a third-party WTRU (e.g., other than a SL reference WTRU and a target WTRU) which may initiate a ranging/SL positioning service request on behalf of the application residing on it.

A ranging/SL positioning operation may be performed using a network-assisted operation or a WTRU-A (e.g., only) operation. In a network-assisted operation, a network function (e.g., the 5GC NF(s) may be involved in the service request handling and/or result calculation. In a WTRU operation (e.g., WTRU-only operation), the service request handling and/or result calculation procedures may be performed by the WTRU.

When network-assisted operation is used, an LMF identified (e.g., defined) in the 5G location service may be used to support triggering SL positioning, coordination of SL positioning operation, and/or delivering the result to the client. The ranging/SL positioning service request may be initiated by a WTRU (e.g., SL positioning client WTRU, target WTRU, SL reference WTRU), a 5GC NF, an LCS Client, or an AF.

When WTRU-a (e.g., only) operation may be used, WTRUs may interact with each other over an interface (e.g., PC5) as necessary in order to perform SL positioning operations. An SL positioning server WTRU may be identified (e.g., defined) to coordinate an SL positioning operation and calculate the positioning result.

An SL positioning server WTRU may be provided. An SL positioning server WTRU may be a WTRU that offers method determination, assistant data distribution, location calculation functionalities, and/or location calculation functionalities for an SL positioning and ranging-based service.

NW assisted SL positioning may be provided. NW assisted SL positioning may be used to estimate the location of a WTRU with the assistance of the network by using the location of one or more located WTRUs and the distance and/or direction between the WTRU and the located WTRU(s).

The network assisted SL positioning feature may have a number of cases, such as two cases. For example, a case may be when the WTRU may establish a NAS signaling connection. For example, a case may be when the WTRU may not establish a NAS signaling connection.

When a WTRU establishes a NAS connection, the WTRU may enter a CM-connected state by performing a WTRU triggered service request for 5GC-MO-LR or a network triggered service request for 5GC-NI-LR or 5GC-MT-LR. When the target WTRU establishes a NAS signaling connection with the AMF, the functionality specified in 5G location service may be reused, for example, 5GC-MO-LR, 5GC-MT-LR, and 5GC-NI-LR. The target WTRU or LMF may determine if network assisted SL positioning may be applied. The target WTRU may discover located WTRU(s) for network assisted SL positioning.

The target WTRU and located WTRU(s) may perform ranging/SL positioning. The target WTRU may include the WTRU identity of the located WTRU(s) to the LMF, for example, with the ranging measurement data, and/or estimation result. The LMF may interact with GMLC to get the location of the located WTRU.

The LMF may use the location of located WTRUs, the ranging or SL positioning measurement data, the estimation results reported by the target WTRU, and/or the estimation results reported by the located WTRUs, to estimate the location of the target WTRU.

The target WTRU may not establish the NAS connection with AMF if the target WTRU is out of coverage. In an example, for 5GC-MO-LR or pending 5GC-MT-LR (e.g., deferred 5GC-MT-LR), a number of principles may be applied. The target WTRU may perform the located WTRU's discovery and selection. The target WTRU may transmit its ranging measurements/results to the located WTRU(s). A located WTRU may report the ranging or SL positioning measurement result to the LMF. This may include ranging measurements or results received from the target WTRU. The endpoints for LPP messages may be the LMF and the located WTRU(s). The LMF may use the received information to calculate the location of the target WTRU. The LMF may provide the resulting location of the target WTRU, for example, via the located WTRU, to the target WTRU. The LMF may provide the resulting location of the target WTRU, for example, via a network function (e.g., a 5G NF), to the LCS client or the AS.

SL positioning service exposure to a WTRU may be provided. A WTRU (e.g., an SL positioning client WTRU) may request SL positioning through PC5 or through an NW.

When an SL positioning client WTRU requests an SL positioning service through a connection (e.g., a PC5 connection), it may discover a reference WTRU and/or a target WTRU, and it may invoke the ranging/SL positioning service request to the discovered reference WTRU/target WTRU (e.g., for obtaining the ranging and SL positioning result between reference WTRU and target WTRU). This request may include the user info of one or more of: the SL positioning client WTRU, the reference WTRU, or the target WTRU.

In NW-assisted SL positioning, there may be varying use cases wherein located WTRUs are used (e.g., two possible use cases based on the presence of a NAS connection).

For example, a use case (e.g., case 1) may be when the target WTRU has a NAS connection. In this case, a located WTRU may be selected for SL positioning, and the location report may be performed by the target WTRU. In this case, the requested capability of a located WTRU may be the located WTRU's availability for Uu positioning and/or capability for SL positioning with target WTRU.

For example, a use case (e.g., case 2) may be when the target WTRU does not have a NAS connection. In this case, a located WTRU may be selected for SL positioning. A location report may be performed by the selected located WTRU. In this case, the requested capability of a located WTRU may be the located WTRU's capability to perform a location report of a target WTRU, for example, with conveying parameters received from the target WTRU. This capability may be in addition to other requested capabilities, such as requested capabilities related to other cases (e.g., as described with respect to the previous use case where a NAS connection is present).

A located WTRU may be selected based on a target WTRU's status. The requested capability of a located WTRU for case 1 and case 2 may be different and may depend on the state of the target WTRU (e.g., in or out of coverage). The target WTRU may be able to select the located WTRU with a requested capability per the target WTRU's state. The located WTRU may be selected per a target WTRU's state.

An SL positioning method may be determined based on a target WTRU's status. A role for one or more WTRUs in the SL positioning method may be determined based on a target WTRU's status. As shown in case 1 and case 2, per the target WTRU's status, the requested role of a located WTRU may be different. Based on the target WTRU's mobility and other circumstances, a target WTRU may gain or lose a connection with a core network (e.g., a NAS connection with 5GC), and the status of the target WTRU may change. The located WTRU and the target WTRU may request (e.g., may need to) to synchronize with each other on the status of the target WTRU so that an SL positioning method and a role of each WTRU may be determined (e.g., based on the target WTRU's status). Examples (e.g., as described herein) may allow one or more WTRUs to synchronize with one another on the status of a target WTRU, to determine an SL positioning method, and/or to determine a role of a (e.g., each) WTRU per the target WTRU's status.

In examples, a WTRU may support PC5 signaling. The PC5 signaling may be supported by the ProSe layer in the WTRUs. In examples, the WTRU may have the capability of ranging and SL positioning. The SL positioning may refer to the positioning via an interface (e.g., the PC5 interface), and ranging may refer to the determination of the distance between two or more WTRUs and/or the direction and/or relative positioning of one WTRU from another WTRU.

A procedure of discovery and selection of located WTRU in model B discovery may be provided. For model B discovery, the target WTRU may send a solicitation message to discover a located WTRU for an SL positioning service. The target WTRU may include the target WTRU's status or requested capabilities of located WTRU so that target WTRU may discover and select the located WTRU, which may be used to perform SL positioning according to the target WTRU's status. The target WTRU and the selected located WTRU may set up a connection, such as a PC5 connection, and may perform SL positioning operation per a target WTRU's status.

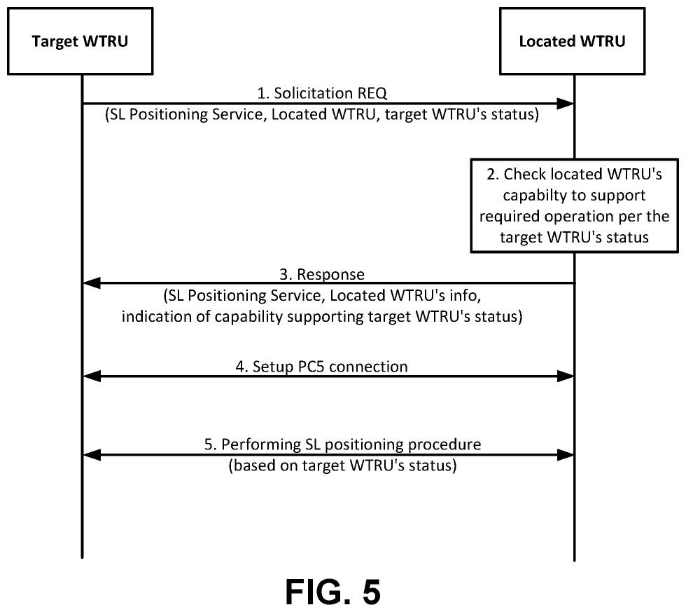

FIG. 5 is a flow diagram illustrating an example method of discovery and selection of a located WTRU (e.g., which may be model B discovery). To discover a located WTRU, at 1 a target WTRU may send a solicitation message. The solicitation message may include ProSe service information indicating SL positioning service and a requested WTRU's type that may be indicated for a located WTRU. The solicitation message may include status information of the target WTRU (e.g., whether the target WTRU has a connection to the network, such as a NAS connection) and/or a requested capability of the located WTRU. The requested capability of the located WTRU may be, for example, a capability to support an SL positioning operation when the target WTRU may not have a connection to the network (e.g., may not have a NAS connection).

In an example, the solicitation message may include the positioning method (e.g., RTT, TDOA, AoA, AoD) that the target WTRU may wish to use.

In another example, the solicitation message may include the location of the target WTRU determined based on a positioning method (e.g., a RAT independent positioning method, such as a GNSS). The target WTRU may indicate the positioning method (e.g., the RAT independent positioning method) used to determine its location.

With continued reference to FIG. 5, at 1, the message (e.g., the target WTRU status IE) may be integrity protected. In examples, the message may have confidentiality protection. If the security association is established at 1, the parameters exchanged at 1-3 may be analyzed (e.g., checked) at 4.

At 2, a located WTRU may receive a solicitation request message to discover a located WTRU for SL positioning service. The located WTRU may check whether it has the capability to support the SL positioning operation included in the solicitation message. The located WTRU's capability may vary based on, for example, the target WTRU's status.

At 3, if the located WTRU supports the requested capability, the located WTRU may respond to the target WTRU with a response message. The response message may include an indication of capability supporting the target WTRU's status. For example, the response message may indicate whether the located WTRU may support the requested capability based on the target WTRU's status or based on the requested capability itself (e.g., as included in the solicitation message at 1).

After sending a solicitation message, the target WTRU may wait for some time so that it may receive responses from multiple located WTRUs.

At 3, the message, or at least the indication of capability supporting target WTRU's status IE, may be (e.g., have to be) at least integrity protected, for example with optional confidentiality protection. If this may not be possible (e.g., due to a lack of security association at 1), the parameters exchanged at 1-3 may be analyzed (e.g., checked) at 4.

At 4, after receiving response message(s), the target WTRU may select a located WTRU for an SL positioning based on a located WTRU's capabilities and other conditions (e.g., link quality). The target WTRU may perform a connection setup (e.g., may perform a PC5 connection setup).

If security for a connection, such as a PC5 connection, may be established during the connection setup (e.g., PC5 setup), the parameters exchanged at 1-3 may be verified. In an example, the parameters exchanged at 1-3 may be performed after the connection is setup.

At 5, the target WTRU and the located WTRU may perform an SL positioning operation. The SL positioning operation may depend on the target WTRU's status.

A procedure of discovery and selection of located WTRU in model A discovery may be provided.

For model A discovery, a located WTRU may send an announcement message including its supported capabilities (e.g., such that it may perform requested procedures for an SL positioning with target WTRU that may not have a connection (e.g., may have no NAS connection). Based on the announced capabilities, the target WTRU may discover and select the located WTRU, which may be used to perform SL positioning according to the target WTRU's status, which may indicate whether the target WTRU may have or may not have a connection (e.g., may or may not have a NAS connection). The target WTRU and selected located WTRU may set up a connection (e.g., may set up a PC5 connection) and may perform SL positioning operation per the target WTRU's status.

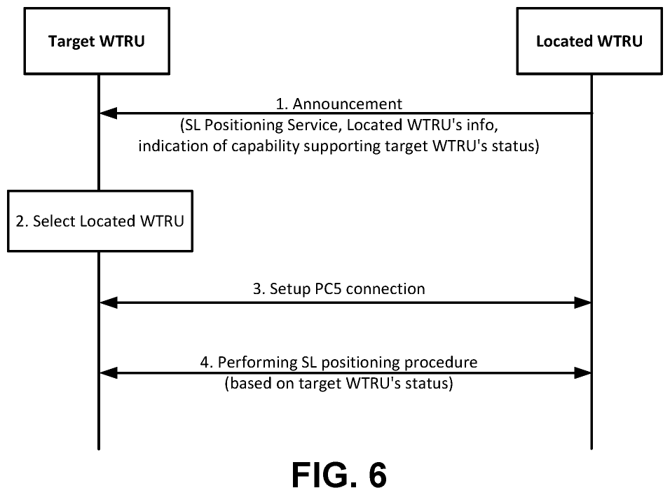

FIG. 6 is a flow diagram illustrating an example procedure of discovery and selection of located WTRU with discovery (e.g., which may be model A discovery), At 1, a located WTRU may send an announcement message to indicate it may support an SL positioning service and may indicate its supported WTRU type (e.g., it may be a located WTRU type). The located WTRU may indicate its capability, for example, to support SL positioning operation when the target WTRU may not have a connection (e.g., it may not have a NAS connection). In an example, the located WTRU may indicate positioning methods (e.g., RTT, TDOA, AoA, AoD) that the located WTRU supports in the announcement message.

At 2, when a target WTRU determines to perform SL positioning, it may discover and select an appropriately located WTRU based on the received announcement message(s) from located WTRU(s). The target WTRU may receive multiple announcement messages from located WTRUs, and the target WTRU may select an appropriately located WTRU that may announce its capability for SL positioning operation to be compatible with the requested capability per target WTRU status. The target WTRU status may indicate that the target WTRU may not have a connection (e.g., it may not have a NAS connection). The target WTRU may select the appropriately located WTRU based on one or more conditions, such as link quality.

At 3, the target WTRU and the selected located WTRU may set up a connection, which may be a PC5 connection. The verification of parameters exchanged at 1 (e.g., an announcement) may be done after 3 or at 3 when connection security is established (e.g., PC5 connection security).

At 4, the target WTRU and the located WTRU may perform an SL positioning operation. The SL positioning operation may be different per the target WTRU's status.

Provisioning of a list of candidate located WTRUs with capabilities may be provided.

A core network, such as a 5GC, may provide a list of candidate located WTRUs for NW assisted SL positioning of the target WTRU via control plane NAS signaling (registration, WTRU configuration update command, WTRU parameter update, SoR, etc.).

The candidate list may include the capability of a (e.g., each) located WTRU such that the located WTRU may perform a requested SL positioning operation with a target WTRU having no NAS connection.

If the core network (e.g., the 5GC) provides the list of candidate located WTRUs with capabilities, the target WTRU may try to discover the located WTRU in the list having the appropriate capability per the target WTRU's status.

In an example, the list provided by the core network (e.g., 5GC) may comprise one or more sets of located WTRUs where a (e.g., each) set may be associated with a different positioning method. For example, a set of located WTRUs may consist of located WTRUs that may support a round-trip time (RTT) positioning method. In an example, a set of located WTRUs (e.g., another set of located WTRUs) may consist of located WTRUs that may support a time difference of arrival (TDOA) positioning method.

If a target WTRU tries to discover the located WTRU in the list with capabilities, it may perform model A or model B discovery without indicating the target WTRU's status and the located WTRU's capability in the related messages. The target WTRU may select an appropriately located WTRU among the discovered located WTRUs by referring to the capability of the discovered located WTRU in the information of the candidate list.

A procedure of an SL positioning protocol with located WTRU may be selected in consideration of a target WTRU's status. While a target WTRU and a located WTRU perform SL positioning, to select an appropriate SL positioning method and to decide a (e.g., each) WTRU's role in the SL positioning operation, the target WTRU may share its status. For example, the target WTRU may indicate whether it has a connection (e.g., a NAS connection) available or not. Based on the target WTRU's status and determined SL positioning method, it may be decided (e.g., by the target WTRU) if the located WTRU or target WTRU may collect a result of SL positioning and report it to the network.

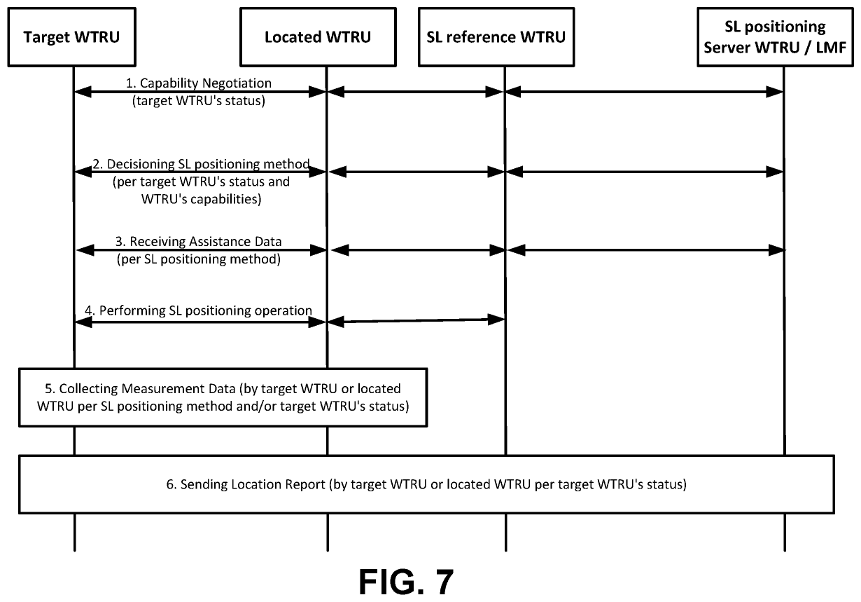

FIG. 7 is a flow diagram illustrating an example procedure of an SL positioning protocol between the target WTRU and located WTRU. At 1, a target WTRU, a located WTRU, a SL reference WTRU, and a SL positioning server WTRU or LMF may communicate for a SL positioning capability negotiation. During capability negotiation, the target WTRU's status denoting that the target WTRU may not have connectivity to the network (e.g., NAS connectivity) and the requested capability of the located WTRU per target WTRU's status may be negotiated.

In an example, the target WTRU's status may be shared separately from capability negotiation via signaling, or pre-configured or pre-acquired information of the target WTRU's status during discovery of a connection setup (e.g., PC5 connection setup) may be reused. In this case, capability negotiation may not include the target WTRU's status.

In an example, a capability negotiation of a target WTRU, a located WTRU, and one or more SL reference WTRUs may happen among the target WTRU, the located WTRU, and the one or more SL reference WTRUs. The SL positioning server WTRU and/or the LMF may be informed of the negotiated capability for the SL positioning decision at 2.

In an example, the functionality of an SL positioning server WTRU may collocate with the target WTRU, the located WTRU, or one or more SL reference WTRUS.

At 2, an SL positioning method may be determined, for example, by a SL positioning server WTRU or a LMF based on the negotiated capability (e.g., that may include a target WTRU's status, a located WTRU's capabilities per the target WTRU's status, and one or more available SL reference WTRUs and their capabilities). Based on the determined SL positioning method, the target WTRU's role and located WTRU's role may be decided at 2.

In an example, an SL positioning method may be determined between a target WTRU and a located WTRU or among a target WTRU, a located WTRU, and one or more SL reference WTRUs. The determination may be based on a negotiated capability that may include a target WTRU's status, a located WTRU's capabilities per the target WTRU's status, and/or one or more SL reference WTRUs and their capabilities.

At 3, assistance data for performing SL positioning may be shared. The assistance data may include characteristics and formatting of transmitted signals, time slots, etc. The assistance data may be provided by a SL positioning server WTRU or a LMF, to the target WTRU, the located WTRU, and/or the one or more SL reference WTRUs involved. This may be based on the determined SL positioning method.

In an example, the assistance data may be shared within the target WTRU, the located WTRU, and the one or more SL reference WTRUs involved. (Pre) configured information at the located WTRU, the target WTRU, and/or the one or more SL reference WTRUs may be used as assistance data for performing SL positioning.

In an example, the positioning method may be determined based on (e.g., by) the number of located WTRUs that have established connections with the target WTRU.

At 4, a located WTRU, a target WTRU, and the one or more SL reference WTRUs may perform the determined SL positioning operation.

At 5, results of the SL positioning operation may be collected at the located WTRU and/or the target WTRU. Based on the SL positioning method and the target WTRU's status, it may be decided if the located WTRU or the target WTRU may collect the result.

At 6, the location report may include the result of the SL positioning operation, and information on the located WTRU may be reported to the LMF or the SL positioning server WTRU. Based on the target WTRU's status, it may be determined if the located WTRU or the target WTRU may convey the location report.

In an example, if the located WTRU may not be able to report the result of the SL positioning operation to the LMF, the target WTRU may receive a message from the located WTRU indicating that the report could not be sent to the LMF. Based on the message, the target WTRU may send a request to the located WTRU at a configured periodicity to send the report to the LMF until the target WTRU receives the message from the located WTRU that the report transmission to the LMF is successful.

The handling of an updated target WTRU's status may be provided during a SL positioning operation.

After capability negotiation, the status of the target WTRU and/or the located WTRU may change. For example, the target WTRU may have lost a connection (e.g., a NAS connection), the target WTRU may have regained a connection (e.g., a NAS connection), and the located WTRU lost a connection (e.g., a NAS connection). A target WTRU or located WTRU may inform the other WTRU of the updated status so that it may be determined that the SL positioning operation may continue or start again.

When the target WTRU's status changes after capability negotiation, the target WTRU or the located WTRU may decide if the current session of an SL positioning operation may continue or if the current SLPP session may be updated per target WTRU's status in consideration of the resource allocation method, synchronization methods, etc.

If the target WTRU decides that the current session may continue regardless of the target WTRU's status change, the target WTRU may not share the updated target WTRU's status with located WTRU until the end of the session.

Although features and elements described above are described in particular combinations, each feature or element may be used alone without the other features and elements of the preferred embodiments or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A first wireless transmit/receive unit (WTRU) comprising:
a processor configured to:
receive a solicitation message from a second WTRU, wherein the solicitation message indicates a status of the second WTRU and service information associated with a sidelink (SL) positioning service;
determine that the first WTRU is capable of providing the SL positioning service based on the status of the second WTRU and the service information; and
send, based on the determination that the first WTRU is capable of providing the SL positioning service, a response message to the second WTRU, wherein the response message indicates the first WTRU is capable of providing the SL positioning service.

2. The first WTRU of claim 1, wherein the solicitation message further indicates a connection status associated with the second WTRU, a positioning method, and a location associated with the second WTRU.

3. The first WTRU of claim 1, wherein the response message further indicates a capability of the first WTRU to perform an SL positioning operation associated with the status of the second WTRU.

4. The first WTRU of claim 1, wherein the processor is further configured to:
receive a connection request message from the second WTRU to establish a connection; and
establish a connection to the second WTRU.

5. The first WTRU of claim 4, wherein the processor is further configured to:
perform an SL positioning operation using the connection to the second WTRU, wherein the SL positioning operation is based on the status of the second WTRU.

6. The first WTRU of claim 5, wherein the SL positioning operation is a synchronization method.

7. The first WTRU of claim 4, wherein the response message is not integrity protected, and wherein the response message is sent via the connection.

8. The first WTRU of claim 1, wherein the response message is integrity protected and confidentiality protected.

9. The first WTRU of claim 1, wherein the status of the second WTRU indicates that the second WTRU has a non-access stratum (NAS) connection available.

10. The first WTRU of claim 1, wherein the status of the second WTRU indicates that the second WTRU does not have a non-access stratum (NAS) connection available.

11. A first wireless transmit/receive unit (WTRU), the first WTRU comprising:
a processor configured to:
receive an announcement message from a second WTRU, wherein the announcement message indicates a service information associated with a sidelink (SL) positioning service, an identity of the second WTRU, and a capability of the second WTRU to support the SL positioning service;
determine that the second WTRU is configured to provide the SL positioning service to the first WTRU based on a status of the first WTRU and the capability of the second WTRU;
establish a connection to the second WTRU based on the determination that the second WTRU is configured to provide the SL positioning service; and
receive a service message from the second WTRU using the connection, wherein the service message is associated with the SL positioning service.

12. The first WTRU of claim 11, wherein the status of the first WTRU indicates that the first WTRU has a non-access stratum (NAS) connection available.

13. The first WTRU of claim 11, wherein the status of the first WTRU indicates that the first WTRU does not have a non-access stratum (NAS) connection available.

14. The first WTRU of claim 11, wherein the announcement message is a first announcement message, and wherein the processor is further configured to:
receive a second announcement message from a third WTRU.

15. The first WTRU of claim 14, wherein the determination that the second WTRU is to provide the SL positioning service is further based on the second announcement message.

16. The first WTRU of claim 15, wherein the determination that the second WTRU is to provide the SL positioning service is further based on a link quality associated with the first WTRU.

17. The first WTRU of claim 11, wherein the processor is further configured to:
receive a candidate list indicating the capability of the second WTRU to support the SL positioning service.

18. The first WTRU of claim 17, wherein the candidate list comprises a first set of WTRUs associated with a first SL positioning service and a second set of WTRUs associated with a second SL positioning service, wherein the first set of WTRUs includes the second WTRU, and wherein the first SL positioning service is the SL positioning service.

19. The first WTRU of claim 11, wherein the SL positioning service is a round-trip time (RTT) positioning method.

20. The first WTRU of claim 11, wherein the SL positioning service is a time difference of arrival (TDOA) positioning method.
